(19) United States
(12) Patent Application Publication
(10) Pub. No.: US 2012/0315005 A1
(43) Pub. Date: Dec. 13, 2012

(54) OPTICAL WAVEGUIDE RIBBON WITH STACK-POSITIONING STRUCTURE

(75) Inventors: Pei-Hua HU, New Taipei (TW); Hsien-Hui HUANG, New Taipei (TW); Shih-Chi CHAN, New Taipei (TW); Yu-Min WANG, New Taipei (TW)

(73) Assignee: HON HAI PRECISION INDUSTRY CO., LTD., New Taipei (TW)

(21) Appl. No.: 13/492,920

(22) Filed: Jun. 10, 2012

(30) Foreign Application Priority Data
Jun. 10, 2011 (TW) 100210532

(51) Int. Cl. G02B 6/44

(52) U.S. Cl. 385/114

(57) ABSTRACT

An optical waveguide ribbon includes a base layer integrated with a plurality of parallel optical cores. The optical waveguide ribbon includes a first surface and a second surface opposite to the first surface. The optical cores extend along a length direction and arrange along a width direction. A first positioning portion is exposed on the first surface with a given shape and a second positioning portion is exposed on the second surface and has a positioning dimension in width according to the given shape of the first positioning portion.

### BACKGROUND OF THE INVENTION

1. Field of the Invention

The present invention generally relates to an optical waveguide ribbon, and more particularly to an optical waveguide ribbon for stacking.

2. Description of Related Art

An optical waveguide is meant to guides electromagnetic waves in the optical spectrum. Optical waveguides notably include optical fibers and rectangular waveguides. They are used as components in integrated optical circuits or as transmission medium in optical communication systems. Such waveguides are usually classified according to their geometry, mode structure, refractive index distribution and material. Of particular interest are the flexible optical waveguide ribbons.

For its precise and hard requirement, the fabrication tolerances of individual waveguide ribbons do not sum-up along the stack. U.S. Pub. No. 2011/0317969 A1 just provide an additional spacer as an outer positioning tool and discloses a method of stacking them. Basically, optical waveguide ribbons (also called flexes) are first positioned in the spacer, such that one ribbon is stacked on another one. Then, a given ribbon is constrained in a respective calibrated space of the spacer, before being fixed. This holds for any vertical imprecision in the positioning of the ribbons. Constraining the layers can for instance be set and/or reinforced by means of an adhesive, e.g. by filling in a space left vacant in the spacer after positioning the elements. The overall precision of the stack is thus easily kept under control. While it is complicate and have many limitations in layer numbers, layer widths, mold cost and so on.

In view of the above, a new optical waveguide ribbon that overcomes the above-mentioned disadvantages is desired.

### SUMMARY OF THE INVENTION

Accordingly, an object of the present invention is to provide optical waveguide ribbon with stack-positioning structure.

In order to achieve the object set forth, an optical waveguide ribbon includes a base layer integrated with a plurality of parallel optical cores. The optical waveguide ribbon includes a first surface and a second surface opposite to the first surface. The optical cores extend along a length direction and arrange along a width direction. A first positioning portion is exposed on the first surface with a given shape and a second positioning portion is exposed on the second surface and has a positioning dimension in width according to the given shape of the first positioning portion.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an optical waveguide ribbon of a first embodiment in accordance with the present invention;

FIG. 2 is a front view of the optical waveguide ribbon shown in FIG. 1;

FIG. 3 is a front view of two stacked optical waveguide ribbon shown in FIG. 1;

FIG. 4 is a front view of an optical waveguide ribbon of a second embodiment in accordance with the present invention.

### DETAILED DESCRIPTION OF THE INVENTION

Reference will now be made in detail to the preferred embodiment of the present invention.

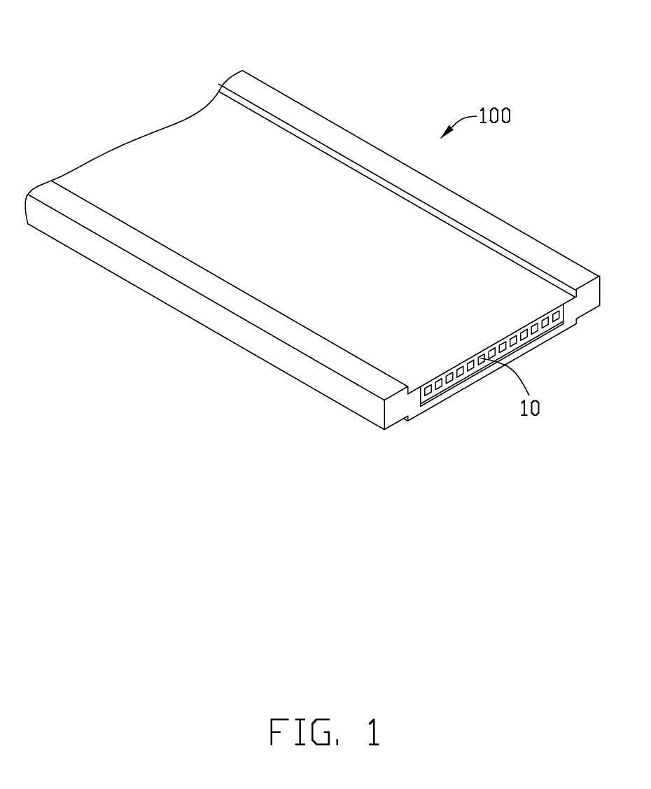

Referring to FIGS. 1-3, an optical waveguide ribbon 100 is used as transmission medium in optical communication systems. The optical waveguide ribbon 100 includes a base layer 101 integrated with a plurality of parallel optical cores 10 and a positioning layer 103 fixed together with the base layer 101 by an inner adhesive layer 102. Each optical core 10 is extending along the longitudinal direction of the optical waveguide ribbon 100 and shows a square section along a lateral cut.

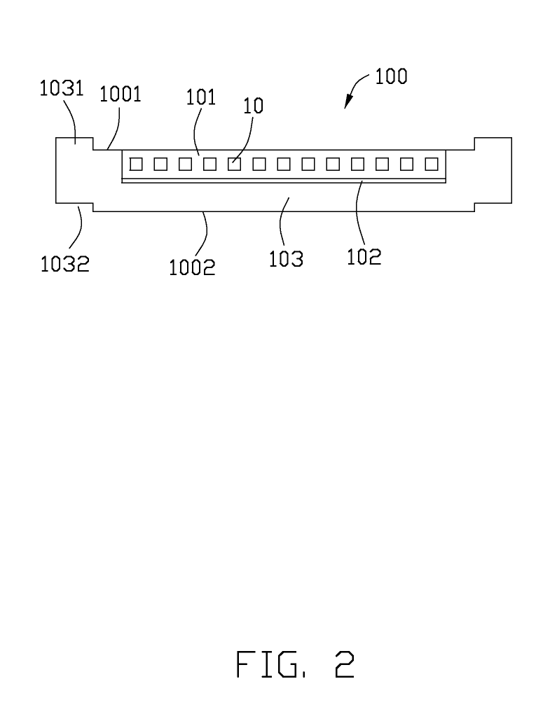

Referring to FIG. 2, the optical waveguide ribbon 100 defines a first surface 1001 and a second surface 1002 opposite to the first surface 1001. The plurality of parallel optical cores 10 are also paralleling to the first and second surface. An upper face of the base layer 101 is flush with the first surface 1001, and a lower face and two longitudinal side faces of the base layer 101 are covered by the positioning layer 103. The positioning layer 103 further forms a first positioning portion 1031 on the first surface 1001 and a second positioning portion 1032 on the second surface 1002. Both the first and second positioning portions are unitarily formed on the positioning layer 103. The first positioning portion 1031 protrudes on the first surface 1001 and continuously extends along two longitudinal sides of the optical waveguide ribbon 100. The second positioning portion 1032 depresses from the second surface 1001 and continuously extends along two longitudinal sides of the optical waveguide ribbon 100. The first positioning portion 1031 has a given first positioning dimension T1 and the second positioning portion 1032 has a complementary second positioning dimension T2. It means that the first positioning dimension T1 is equal to and will be match the second positioning dimension T2 and of course a certain tolerance is allowed.

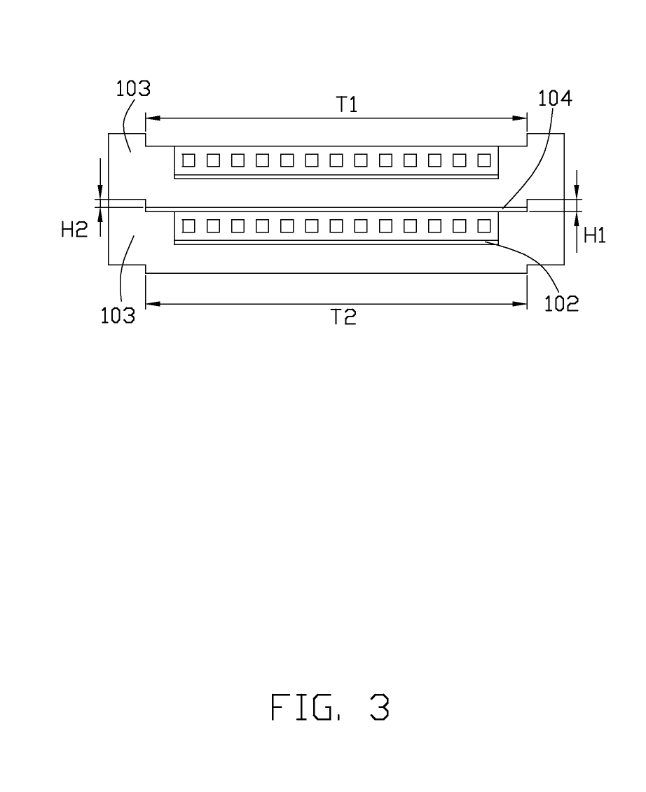

The optical waveguide ribbon 100 can be laterally cut into two or more equal sections and than stack the sections together. Combination with FIG. 3, it just shows a stacked assembly with an upper layer and a lower layer (optical waveguide ribbon). Due to the dimension design of the first and second positioning portion, the first positioning portion 1031 of the lower layer and the second positioning portion 1032 of the upper layer insert into and mate with each other. Please note that a protruding distance H1 of the first positioning portion 1031 is greater than a depressing distance H2 of the second positioning portion 1032 such that a little gap (not labeled) is left therebetween. An outer adhesive layer 104 is filled or placed in the little gap to fix the lower and upper layer together. The orderly stacked positioning portion 103 (comprising first positioning portion 1031 and second positioning portion 1032), inner adhesive layer 102, base layer 101 and outer adhesive layer 104 cooperatively forms a convenient guiding and precise mating unit during manufacturing and stacking process.

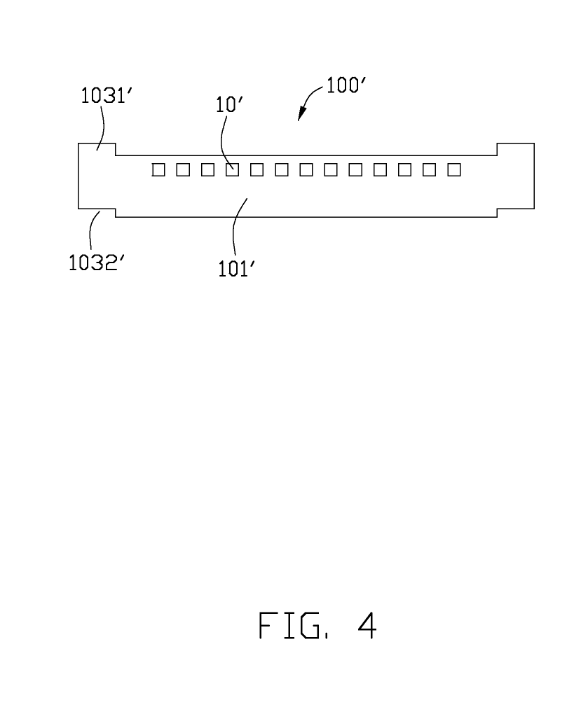

FIG. 4 shows a second embodiment of the invention, which gives an illustration of an optical waveguide ribbon 100′ wherein descriptions of the same and similar element are omitted. The first positioning portion 1031′ and the second positioning portion 1032′ are unitarily formed on the base layer 101′ with optical cores 10′ embedded such that separate base layer, positioning layer and process of fixing them together with inner adhesive layer are omitted and simplified, while the cost may increase because of different materials of the base layer and the positioning layer.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

We claim:

1. An optical waveguide ribbon comprising:
a plurality of parallel optical cores, the optical cores extending along a length direction and arranged along a width direction perpendicular to the length direction;
a first surface and a second surface opposite to the first surface;
a first positioning portion exposed on the first surface with a given shape;
a second positioning portion exposed on the second surface and having a positioning dimension in width according to the given shape of the first positioning portion.

2. The optical waveguide ribbon as claimed in claim 1, wherein the optical waveguide ribbon includes a base layer integrated with the optical cores and a positioning layer fixed onto the base layer, the first and second positioning portions are unitarily formed on the positioning layer.

3. The optical waveguide ribbon as claimed in claim 2, wherein an upper face of the base layer is flush with the first surface, and a lower face and two width side faces of the base layer are covered by the positioning layer.

4. The optical waveguide ribbon as claimed in claim 3, wherein the first positioning portion is a pair of projections protruding out of the first surface and extending along the length direction, the second positioning portion is a pair of cuts located on the second surface.

5. The optical waveguide ribbon as claimed in claim 4, wherein the pair of projections is located on both width sides of the optical waveguide ribbon and continuously extending along the length direction.

6. The optical waveguide ribbon as claimed in claim 1, wherein the optical waveguide ribbon includes a base layer integrated with the optical cores, the first positioning portion and the second positioning portion are unitarily formed on the base layer.

7. The optical waveguide ribbon as claimed in claim 1, wherein the first and second positioning portions are regularly spaced on the first and second surfaces for regularly cutting along the length direction.

8. An optical waveguide ribbon assembly comprising:
an upper waveguide ribbon and a lower waveguide ribbon having a same cross section;
each of the upper and lower waveguide ribbons having a first surface and a second surface opposite to the first surface;
a first positioning portion located on the lower waveguide ribbon and a second positioning portion located on the upper waveguide ribbon commonly form a little gap for placing an outer adhesive layer.

9. The optical waveguide ribbon assembly as claimed in claim 8, wherein each of the upper and the lower waveguide ribbon comprises a base layer integrated with a plurality of optical cores and a positioning layer fixed onto the base layer, an inner adhesive layer is placed between the base layer and the positioning layer.

10. The optical waveguide ribbon assembly as claimed in claim 9, wherein the upper and lower waveguide ribbons are cut from a same optical waveguide ribbon.

11. The optical waveguide ribbon assembly as claimed in claim 9, wherein the optical waveguide ribbon assembly comprises two or more layers.

12. The optical waveguide ribbon assembly as claimed in claim 9, wherein the positioning layer covers a lower face and two width side faces of the base layer.

13. The optical waveguide ribbon assembly as claimed in claim 12, a pair of projections is protruded on both width sides of the first and second optical waveguide ribbons and continuously extending along the length direction to form the second positioning portion.

14. An optical waveguide ribbon comprising:
a base layer enclosing a plurality of parallel optical cores;
a positioning layer associated with and located under the base layer in a vertically stacked manner;
an upper positioning portion formed around an upper surface of the base layer;
a lower positioning portion formed around a lower surface of the positioning layer and configured to comply and aligned with the upper positioning portion in a vertical direction; wherein
when two of said optical waveguide ribbons are stacked with each other, the lower positioning portion of an upper one of said two of said optical waveguide ribbons is adapted to be engaged with the upper positioning portion of a lower one of said two of said optical waveguide ribbons under condition that a gap is formed, in the vertical direction, between the lower surface of the positioning layer of the upper one of said two of said optical waveguide ribbons and the upper surface of the base layer of the lower one of said two of said optical waveguide ribbons for adhesive filling.

15. The optical waveguide ribbon as claimed in claim 14, wherein in each optical waveguide ribbon the base layer and the positioning layer defines a gap therebetween in the vertical direction for adhesive filling.

16. The optical waveguide ribbon as claimed in claim 14, wherein the upper positioning portion and the lower positioning portion are located on a periphery of a combination of said base layer and said positioning layer.

17. The optical waveguide ribbon as claimed in claim 14, wherein the upper positioning portion and the lower positioning portion share a same width.

18. The optical waveguide ribbon as claimed in claim 14, wherein the upper positioning portion protrudes outwardly beyond the upper surface of the base layer while the lower positioning portion is recessed inwardly in the lower surface of the positioning layer.

19. The optical waveguide ribbon as claimed in claim 14, wherein the upper positioning portion is dimensioned larger than the lower positioning portion in the vertical direction.

20. The optical waveguide ribbon as claimed in claim 14, wherein in each optical waveguide ribbon the base layer is unitarily formed with the positioning layer without a gap therebetween in the vertical direction.
